(19) United States
(12) Patent Application Publication
(10) Pub. No.: US 2012/0045665 A1
(43) Pub. Date: Feb. 23, 2012

(54) BATTERY PACK

(75) Inventor: Han-Kyu PARK, Yongin-si (KR)

(73) Assignee: Samsung SDI Co., Ltd., Yongin-si (KR)

(21) Appl. No.: 13/042,816

(22) Filed: Mar. 8, 2011

Related U.S. Application Data
(60) Provisional application No. 61/374,563, filed on Aug. 17, 2010.

(51) Int. Cl. H01M 2/10; H01M 10/42

(52) U.S. Cl. 429/7; 429/159

(57) ABSTRACT

The embodiment relates to a battery pack having improved durability and safety by forming fixing ribs in a holder case mounted on a plurality of battery cells to fix the battery cells and a lead wire in implementing the battery pack. A battery pack according to the present invention includes: a plurality of battery cells electrically connected by connection tabs; a holder case covering a portion of the outer surfaces of the battery cells; a protection circuit module mounted on the holder case; and a lead wire connecting the protection circuit module with the battery cells, in which the holder case has at least one fixing rib that fixes the battery cells and guides the lead wire.

### RELATED APPLICATIONS

This application claims the benefit of U.S. Provisional Application No. 61/374,563, filed Aug. 17, 2010, entitled Battery Pack which is hereby incorporated in its entirety by reference herein.

### BACKGROUND

1. Field of the Invention

The embodiment relates to a battery pack, in more detail, a battery pack having improved durability and safety.

2. Discussion of Related Art

In general, a battery pack composed of a plurality of battery cells connected in parallel and/or in series is used for devices, such as laptops and electric vehicles. The battery cells are connected by connection tabs with adjacent battery cells. Further, the battery cells are mounted in a case.

### SUMMARY OF THE INVENTION

In one embodiment the invention provides a battery pack that can protect a plurality of battery cells against vibration, shock, and drop, by having fixing ribs that fix the battery cells in a holder case mounted on the battery cells.

The present invention, in one embodiment, also provides a battery pack that includes a means for fixing a lead wire to the holder case.

According to an aspect of the present invention, there is provided a battery pack that includes: a plurality of battery cells electrically connected by connection tabs; a holder case covering a portion of the outer surfaces of the battery cells; a protection circuit module mounted on the holder case; and a lead wire connecting the protection circuit module with the battery cells, in which the holder case has at least one fixing rib that fixes the battery cells and guides the lead wire.

The holder case, in one embodiment, includes a cover covering at least a portion of the battery cells, and a first extender and a second extender that extend from the cover, adjacent to both ends of the battery cells, in which the fixing ribs are disposed on the first extender and the second extender.

The battery cells, in one embodiment, are electrically connected by the connection tabs.

The fixing ribs, in one embodiment, are disposed outside the connection tabs, on the first extender and the second extender, to prevent the battery cells from moving.

The fixing rib, in one embodiment, is formed on the first extender and the fixing rib formed on the second extender are alternately disposed, in a zigzag shape when seeing the holder case from above.

The fixing rib, in one embodiment, is shaped to be divided left and right with a gap therebetween and the gap may be a lead wire-through hole.

Further, in one embodiment, a protrusion is formed outside the fixing rib to prevent the lead wire from protruding outside.

Further, in one embodiment, the first extender and the second extender may contact the upper portion and the lower portion of the battery cells and match with the outer circumference of the battery cells.

Further, in one embodiment, the lead wire is connected with the connection tab at one end and with the protection circuit module at the other end.

Further, in one embodiment, a guide groove that guides the lead wire passing through the lead wire-through hole may be further formed on the first extender and the second extender.

In this configuration, a protruding rib fixing the lead wire may be formed on the inner surface of the guide groove. In this configuration, the protruding rib may protrude in a constant thickness on both inner sides of the guide groove. Further, the protruding rib may protrude only at the inlet of the guide groove.

The holder case, in one embodiment, may be divided left and right and fastened to each other.

An external case, in one embodiment, may be provided on the holder case.

The external case, in one embodiment, may be composed of a first case and a second case, which are fastened to each other.

The inner surface, in one embodiment, of any one of the first case and the second case that contact an anti-interference portion of the holder case may be formed in order not to interfere with the guide groove.

According to the present invention, it is possible to better protect the battery cell from external vibration, shock, and drop by forming the fixing ribs in the holder case, such that it is possible to improve durability of the battery pack.

Further, it is possible to prevent or at least inhibit the lead wire from being cut by fixing the lead wire through the lead wire-through hole of the fixing rib, such that it is possible to improve safety of the battery pack.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a front perspective view showing when a holder case is mounted on a plurality of battery cells according to the present invention;

FIG. 1B is a rear perspective view showing when the holder case is mounted on the battery cells according to the present invention;

FIG. 1C is a view schematically showing when the holder case is mounted and fixed to the battery cells according to the present invention;

FIG. 2 is a perspective view of the holder case according to the present invention;

FIG. 3 is a perspective view enlarging the portion A of FIG. 2;

FIG. 4A is a perspective view enlarging the portion B of FIG. 2;

FIG. 4B is a perspective view showing a protruding rib different from that shown in FIG. 4A;

FIG. 5A is a perspective view enlarging the portion C of FIG. 2;

FIG. 5B is a perspective view showing a guide member different from that shown in FIG. 5A;

FIG. 6 is a perspective view showing when an insulating sheet according to the present invention is attached; and

FIG. 7 is a perspective view showing a battery back equipped with an external case according to the present invention.

### DETAILED DESCRIPTION OF THE INVENTION

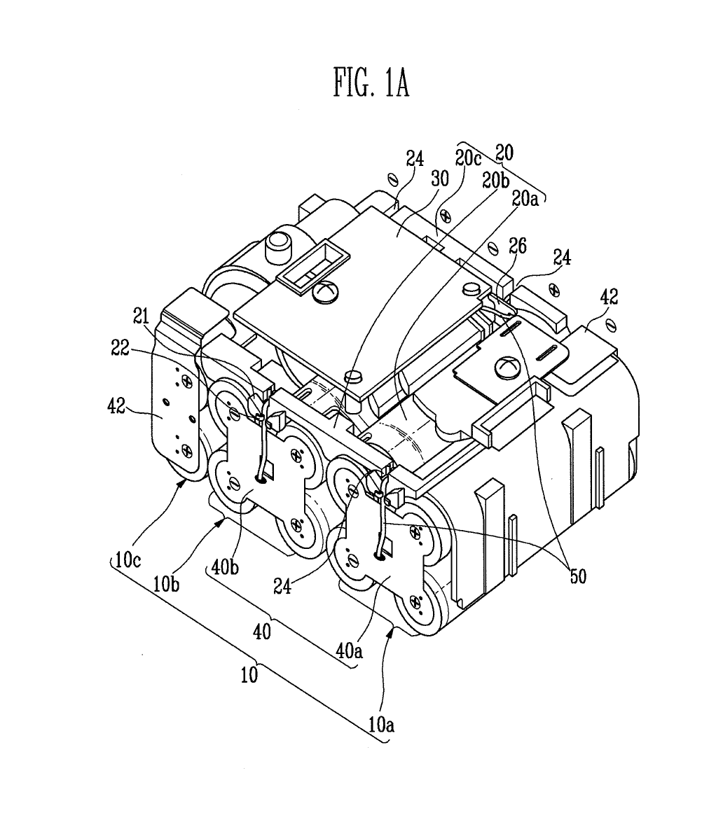

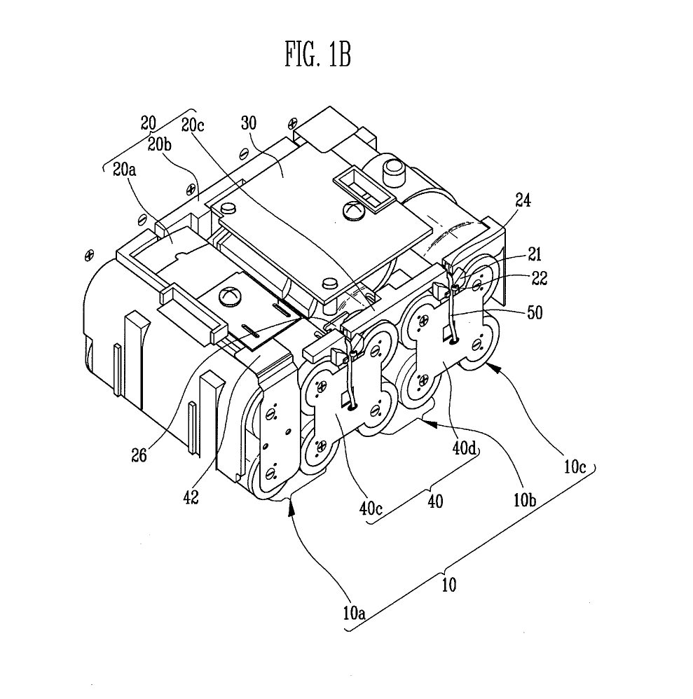

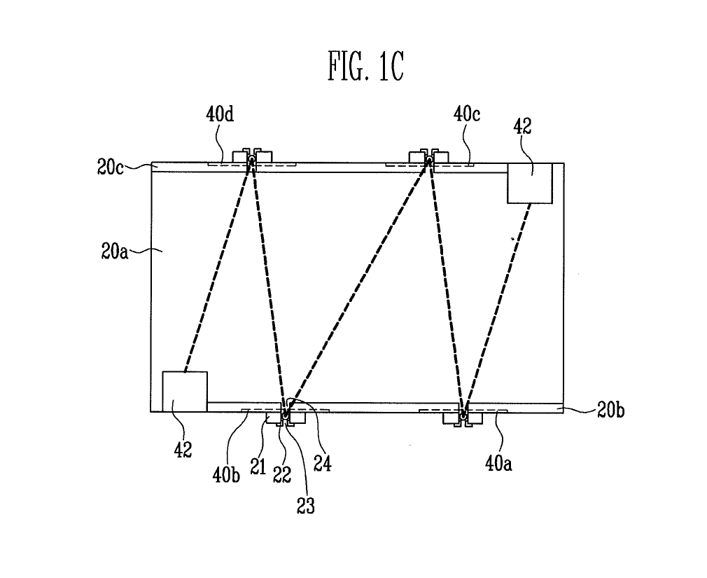

FIG. 1A is a front perspective view showing when a holder case is mounted on a plurality of battery cells according to the present invention and FIG. 1B is a rear perspective view showing when the holder case is mounted on the battery cells according to the present invention.

Referring to FIGS. 1A and 1B, a battery pack according to one embodiment of the present invention includes a plurality of battery cells 10, a holder case 20, a protection circuit module 30, a lead wire 50, and fixing ribs 21.

First, the battery cells 10 are chargeable/dischargeable cylindrical lithium ion batteries. The battery cells 10 according to an embodiment of the present invention are arranged in a five-series and two-parallel structure (5 S*2 P). That is, five sets of battery cell group which has a set of two battery cells connected in parallel are connected by connection tabs. The connection tabs 40 are conductive devices made, for example, of copper etc. and electrically connect the battery cell groups.

Hereinafter, connection relationship of the battery cell groups is described in more detail with reference to FIG. 1A. Basically, two battery cells are connected in parallel. One end of each of the battery cells connected in parallel has a first pole and the other end has a second pole. The first poles of the battery cells are electrically connected to the protection circuit module by the connection tab 42 in FIG. 1A. T he second poles of the battery cells are electrically connected with the first poles of the adjacent battery cells by the connection tab 40d in FIG. 1B. The battery cells having the second poles at the other end are electrically connected with the first poles of the next battery cells by the connection tab 40b. Therefore, total five groups of battery cells are connected in series and the second poles of the last battery cells are electrically connected with the protection circuit module 30 by the connection tab 42. Meanwhile, it should be understood that the five-series and two-parallel structure (5 S*2 P) is exemplified, but the structure is not limited thereto and various connection structures may be used, if needed.

Meanwhile, the holder case 20 of the present invention may be formed to cover at least a portion of the battery cells 10. In an embodiment of the present invention, the holder case 20 includes a cover 20a that covers the outer surfaces of the battery cells 10, and a first extender 20b and a second extender 20c disposed close to both ends of the battery cells 10, in the cover 20a. The first and second extenders 20b, 20c may extend to the spaces defined between adjacent battery cell groups. That is, the ends of the first and second extenders 20b, 20c may be formed in a shape matching with the circumference of the cylindrical battery cells 10, in which it is possible to prevent the battery cells from moving due to external shock.

Further, the first and second extenders 20b, 20c have at least one or more fixing ribs 21 at both ends of the battery cells 10 to maintain and fix the position of the battery cells 10. Further, the fixing ribs 21 also have a function of guiding the lead wire 50 electrically connecting the battery cells 10 with the protection circuit module 30.

The fixing ribs 21 are formed to contact the ends of the battery cells 10 and may be formed between the battery cells 10. Referring to FIG. 1A, the fixing rib 21 may be formed on the first extender 20b at the positions corresponding to the positions of the connection tabs 40a, 40b. Referring to FIG. 1B, the fixing rib 21 may be formed on the second extender 20c at the positions corresponding to the positions of the connection tabs 40c, 40d. That is, the first extender 20b extending from the cover 20ab is positioned at the ends of the battery cells 10 and the second extender 20c is positioned at the other ends of the battery cells 10, such that the fixing ribs are alternately formed at both ends of the battery cells 10, thereby firmly fixing the battery cells 10 at their positions.

The positions where the fixing ribs 21 are formed may construct a zigzag shape, when seeing the holder case 20 from above. FIG. 1C is a plan view schematically showing the top of the holder case 20, seen from above as described above. That is, as shown in FIG. 1C, the fixing ribs 21 may be formed on the first extender 20b and the second extender 20c while being positioned on the first, second, third, and fourth connection tabs 40a, 40b, 40c, 40d. Further, the battery cells (10 in FIG. 1A) fixed by welding with the first, second, third, and fourth connection tabs 40a, 40b, 40c, 40d are supported by the fixing ribs 21. Therefore, the fixing ribs 21 disposed in a zigzag shape prevent or inhibit the battery cells (10 in FIG. 1A) from moving and also prevent the connection tabs 40 fixed to the battery cells from separating. That is, it is possible to improve durability of the battery pack against shock, drop, and vibration. Meanwhile, referring to FIG. 1C, the battery cells are fixed in a zigzag shape in order not to be moved by the first, second, third, and fourth connection tabs 40a, 40b, 40c, 40d formed on the first extender 20b and the second extender 20c. Further, the lead wire (not shown) passes through the first and second extenders 20b, 20c of the holder case, through the fixing rib 21 and a lead wire-through hole 23 formed in the fixing rib 21. In this configuration, guide grooves 24 are formed on the first and second extenders 20b, 20c such that the lead wire 50 can be guided without protruding outside. This is described in detail below.

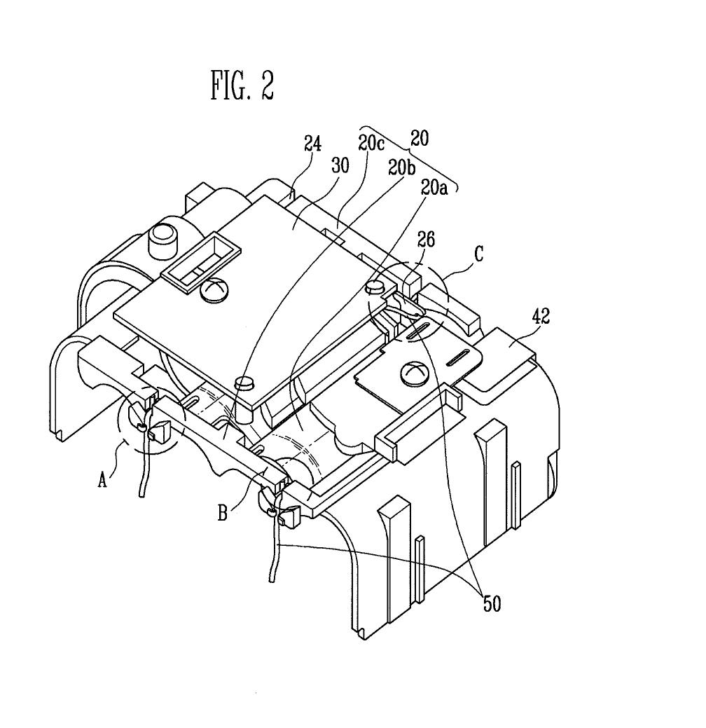

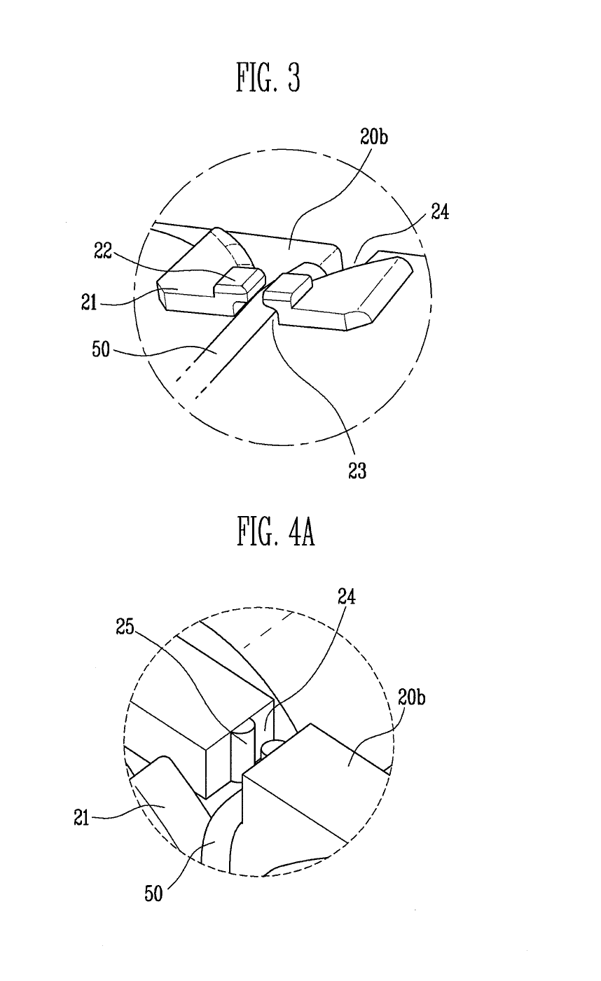

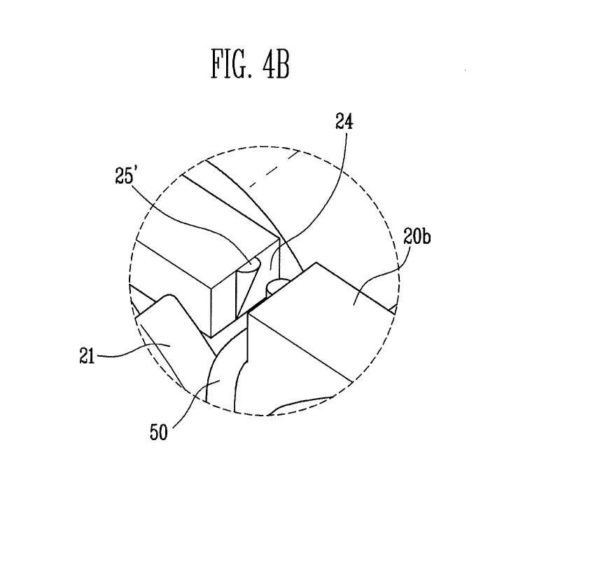

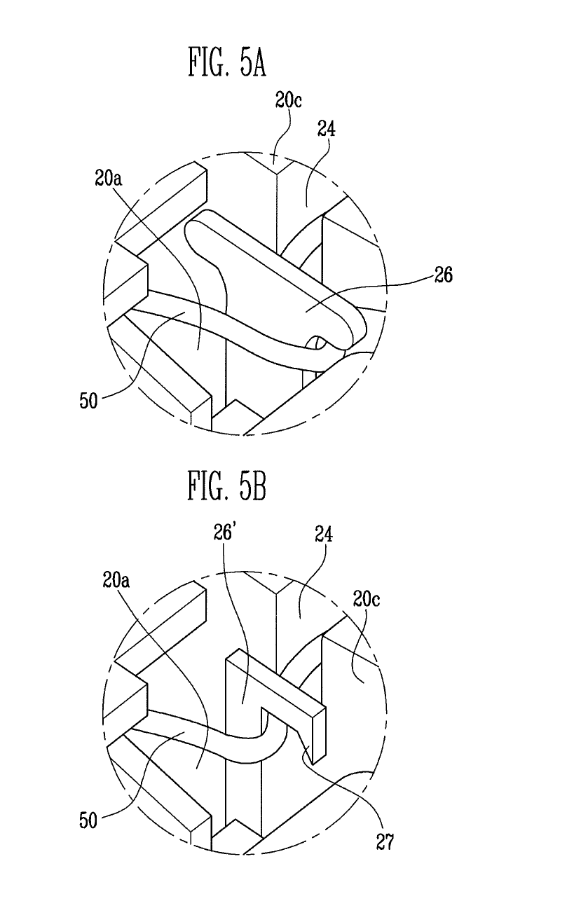

FIG. 2 is a perspective view of the holder case according to one embodiment of the present invention, FIG. 3 is a perspective view enlarging the portion A of FIG. 2, FIG. 4A is a perspective view enlarging the portion B of FIG. 2, FIG. 4B is a perspective view showing a protruding rib different from that shown in FIG. 4A, FIG. 5A is a perspective view enlarging the portion C of FIG. 2, and FIG. 5B is a perspective view showing a guide member different from that shown in FIG. 5A.

As shown in FIGS. 2 to 3, the fixing rib 21 is formed on the first extender 20b of the holder case (20, see FIG. 1) to support the connection tabs 40a, 40b, 40c, 40d positioned at the ends of the battery cells 10. The fixing rib 21 may be divided left and right with a predetermined gap therebetween and the gap may be the lead wire-through hole 23 for guiding the lead wire 50. Further, protrusions 22 may be formed to protrude from both sides facing the lead wire-through hole of the fixing rib 21. The protrusions 22 function as locking member that prevent the lead wire passing through the lead wire-through hole 23 from being pulled out.

Further, the fixing rib 21 may be formed with the smallest area contacting the lead wire 50. That is, it is possible to minimize or at least reduce the contact area between the lead wire 50 and the fixing rib 21 by making the middle portion of the fixing rib 21 where the lead wire-through hole 23 is formed, smaller than the side of the fixing rib 21 which contacts the connection tab 40. This is because the coating of the lead wire 50 may peels off by the fixing rib 21, when shock is applied to the battery cells due to drop etc.

Further, the guide grooves 24 through which the lead wire 50 adjacent the fixing ribs 21 can pass may be further formed on the first extender and the second extender 20b, 20c. That is, the guide grooves 24 for guiding the lead wire 50 from the first extender and the second extender 20b, 20c of the holder case 20 when connecting the lead wire 50 passing through the lead wire-through hole 23 from the battery cells 10 to the protection circuit module 30 may be further formed. Protruding ribs 25, 25′ fixing or supporting the lead wire 50, which passes through, may be further formed inside the guide grooves 24.

The protruding rib 25 shown in FIG. 4A may protrude at a constant thickness on both inner sides of the guide groove 24. Therefore, it is possible for the lead wire 50 inserted in the guide groove 24 to be inhibited from being separated outside. The protruding rib 25′ shown in FIG. 4B may have a shape that decreases in thickness toward the inside of the guide groove 24. Therefore, the lead wire 50 press-fitted in the guide groove 24 can be seated inside the guide groove 25 without contacting the protruding rib 25′. That is, the lead wire 50 can move inside the protruding rib 25′, but cannot be separated outside from the guide groove 24 by the protruding rib 25′. Further, though not shown, the protruding rib may protrude only at the inlet of the guide groove.

A guide member 26 fixing the lead wire 50 not to be horizontally move may be further formed at the cover 20a of the holder case 20. The guide members 26, 26′ described above are show in detail in FIGS. 5A and 5B. First, referring to FIG. 5A, the guide member 26 that guides the lead wire 50 is further formed at the cover 20a (see FIG. 1) of the holder case 20. The guide member 26 is formed in a T-shape to fix the lead wire 50 not to horizontally move. FIG. 5B is a perspective view showing a guide member different from that shown in FIG. 5A. Referring to FIG. 5B, the guide member 26′ may be formed in an inverse L-shape with a hook 27 at the end. Therefore, similar to the guide member 26 of FIG. 5A, it can fix the lead wire 50 not to horizontally move while guiding the lead wire.

Further, the lead wire 50, in one embodiment, is coated with a vinyl tube and connects the protection circuit module 30 with the battery cell 10. In this configuration, the lead wire 50 may be a monitoring lead wire that can measure cell balancing. The lead wire 50 may be connected with the connection tab 40 at one end and with the protection circuit module 30 at the other end. In this configuration, one end of the lead wire 50 may be connected with the connection tab 40 by soldering. It is possible to check whether current flows well to the battery cells 10, using the lead wire 50.

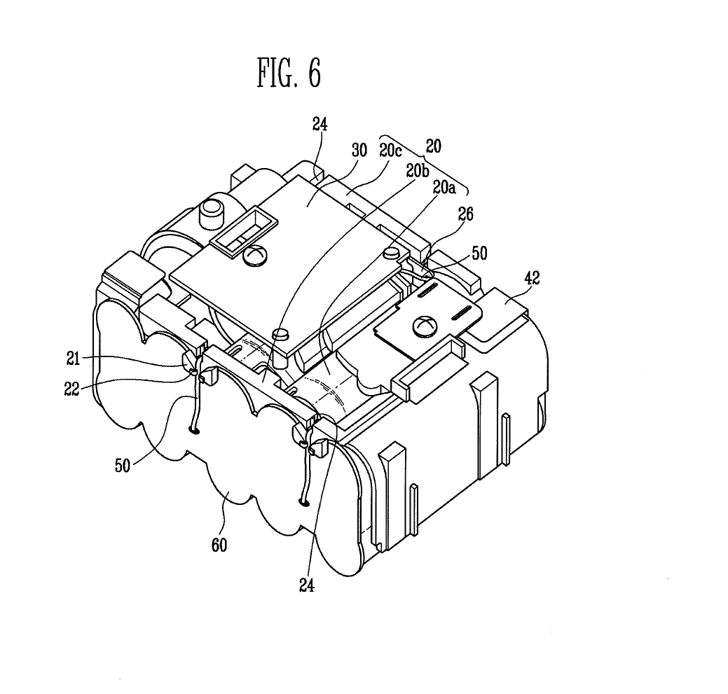

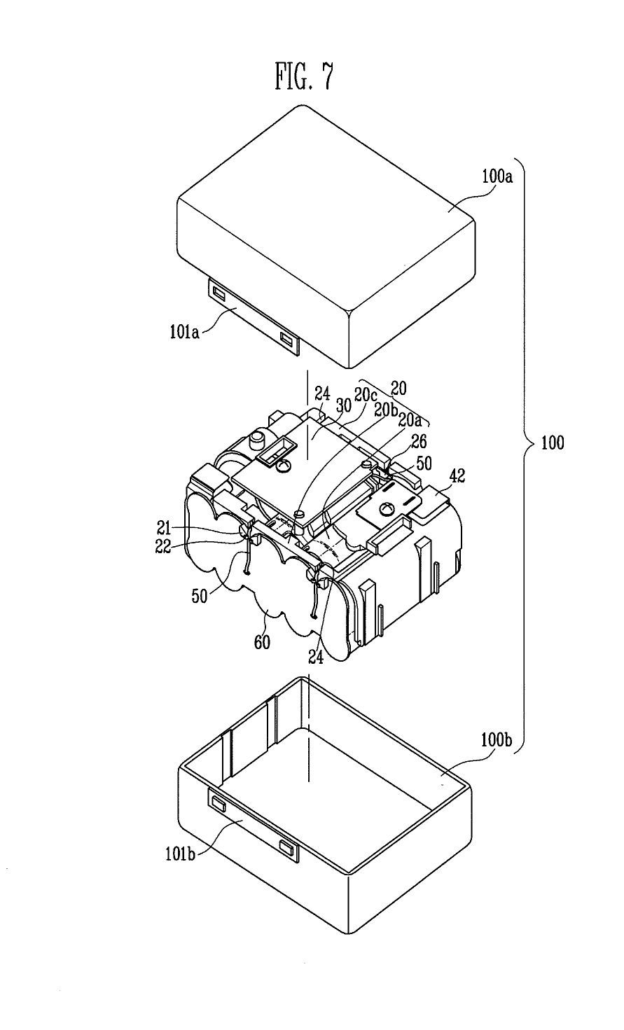

FIG. 6 is a perspective view showing the battery pack with an insulating sheet according to one embodiment of the present invention.

Referring to FIG. 6, the insulating sheet 60 is provided to prevent or inhibit contact between the connection tab 40 (see FIG. 1) connected with the first an second poles of the battery cells 10 by welding and the external case 100 (see FIG. 7) which is the finish material. It is preferable that the insulating sheet 60 is made of a material having high thermal resistance in order to be prevented from being damaged by heat generated when current flows through the connection tab 40 or the lead wire 50.

Further, the protection module 30 may be installed at the cover 20a of the holder case 20. Electronic components are mounted on the protection circuit module 30, thereby implementing a protection circuit. The protection circuit module 30 is fixed to the holder case 20 by bolts, but may be fixed by other fasteners.

FIG. 7 is a perspective view showing a battery back equipped with an external case according to one embodiment of the present invention.

Referring to FIG. 7, an external case 100 may be further provided around the holder case 20 covering the battery cell 10. The external case 100 may be divided into a first case 100a and a second case 100b, which are fastened to each other. The first case 100a and the second case 100b may be fastened by a groove 101a and a protrusion 101b, which are formed at the cases, respectively.

Though not shown in the figures, the first case 100a and the second case 100b may be fixed by bolts or fitting. Further, a groove and a protrusion for combination may be formed on the inner sides facing each other of the first case 100a and the second case 100b.

In this configuration, the inner surface of the case 100a which contacts the first extender 20b of the holder case 20 may be formed in order not to interfere with the guide groove 24. That is, it is formed such that the lead wire 50 inserted in the guide groove 24 does not directly contact the first case 100a. Therefore, it is possible to prevent the coating of the lead wire 50 from peeling off.

Although the cylindrical battery cells are used in the embodiments of the present invention, it should be noted that other shapes of battery cells may be used.

Although the spirit of the present invention was described in detail with reference to the preferred embodiments, it should be understood that the embodiments are provided only for explaining the present invention and the present invention is not limited thereto. Further, it should be understood that the present invention may be modified in various ways by those skilled in the art, without departing from the scope of the present invention.

The scope of the present invention described above is determined by the following claims and not limited to the detailed description described herein, and equivalent changes and modifications within claims are included in the spirit and scope of the present invention.

What is claimed is:

1. A battery pack comprising:
a plurality of batteries having a first and a second end that are arranged in a first orientation wherein batteries are aligned so as to be substantially parallel to each other;
a holder case that receives the plurality of batteries, wherein the holder case includes one or more fixing members that engage with at least some of the plurality of batteries to maintain at least some of the plurality of batteries in the first orientation; and
at least one connection tab that is coupled to at least one of the first or second end of the batteries wherein the at least one connection tab is exposed when the batteries are positioned within the holder case.

2. The battery pack of claim 1, further comprising a protection circuit module mounted on the holder case wherein the plurality of batteries are connected to the protection circuit module via at least one lead wire and wherein the fixing members are further positioned and dimensioned so as to secure the lead wires and guide the lead wires to the protection circuit module.

3. The battery pack of claim 1, wherein the holder case defines a cover that is positioned so as to extend along the length of one or more of the batteries.

4. The battery pack of claim 1, wherein the holder case includes at least one extension member that is positioned proximate to at least the first end of at least some of the plurality of batteries.

5. The battery pack of claim 4, wherein the at least one extension member includes the one or more fixing member that engages with one of the batteries to maintain the battery in alignment with an adjacent battery.

6. The battery pack of claim 5, wherein the extension member includes a plurality of fixing members so that a fixing member engages with the first end of each of the substantially parallel batteries so as to maintain the plurality of substantially parallel batteries in alignment with each other.

7. The battery pack of claim 4, wherein the extension member includes at least one guide groove that receive a lead wire.

8. The battery pack of claim 7, wherein the extension member include a protrusion that is formed on an inner surface of the guide groove and extends into the guide groove to retain the lead wire.

9. The battery pack of claim 8, wherein the protrusion is of constant thickness along the height of the guide groove .

10. The battery pack of claim 8, wherein the protrusion is of varying thickness along the height of the guide groove .

11. The battery pack of claim 2, wherein the one or more fixing members are positioned so as to be arranged in pairs so as to define a through hole formed therebetween and wherein the through hole is sized so as to receive and retain the lead wire.

12. The battery pack of claim 11, wherein the plurality of fixing members include at least one protrusion that extends into the through hole to retain the lead wire.

13. The battery pack of claim 4, wherein the at least one extension member comprises a first and a second extension member that is positioned proximate the first and the second ends of the parallel batteries and wherein a plurality of fixing members are formed on the first and the second extension members and engage the first and second ends of the plurality of substantially parallel batteries so as to maintain the batteries in a substantially parallel fashion.

14. The battery pack of claim 13, wherein the plurality of fixing members are arranged between the first and the second extension member so as to define a zig-zag pattern.

15. The battery pack of claim 2, further comprising a guide member that is positioned on the holder case so as to inhibit horizontal movement of the lead wire.

16. The battery pack of claim 15, wherein the guide member comprises a T shaped member that engages with the lead wire so as to inhibit horizontal movement of the lead wire.

17. The battery pack of claim 15, wherein the guide member comprises an inverse L-shaped member having a hook that engages with the lead wire so as to inhibit horizontal movement of the lead wire.

18. The battery pack of claim 1, further comprising at least one insulating sheet positioned over the at least one connection tab so as to provide insulation to the at least one connection tab.

19. The battery pack of claim 1, further comprising an external case that is positioned around the holder case covering the battery cell.

20. The battery pack of claim 19, wherein the external case comprises a first and a second case that are fixed together.
